(19) United States
(12) Patent Application Publication
(10) Pub. No.: US 2013/0159524 A1
(43) Pub. Date: Jun. 20, 2013

(54) COMMUNICATION DEVICE, COMMUNICATION SYSTEM, AND SESSION CONTROL METHOD

(71) Applicant: FUJITSU LIMITED, Kawasaki-shi (JP)

(72) Inventors: Masaki Takahashi, Shinjuku (JP); Hideki Iwamura, Sagamihara (JP); Hiroaki Komine, Yamato (JP); Takafumi Yamashina, Hadano (JP); Junichi Nishi, Yokohama (JP)

(73) Assignee: FUJITSU LIMITED, Kawasaki-shi (JP)

(21) Appl. No.: 13/688,440

(22) Filed: Nov. 29, 2012

(30) Foreign Application Priority Data
Dec. 20, 2011 (JP) 2011-278062

(51) Int. Cl. H04L 29/06

(52) U.S. Cl. CPC H04L 65/1066
USPC 709/225

(57) ABSTRACT

A communication device includes a storage device configured to store plural addresses assigned to the communication device, a user interface device, and a controller, wherein the controller executes processing that accepts an input of a user due to the user interface device, and address switching processing that causes a transmission destination address, used by an opposite device to transmit data to the communication device, to be switched to another address included in the plural addresses in accordance with the session control protocol, in response to the input.

### CROSS-REFERENCE TO RELATED APPLICATION

This application is based upon and claims the benefit of priority of the prior Japanese Patent Application No. 2011-278062, filed on Dec. 20, 2011, the entire contents of which are incorporated herein by reference.

### FIELD

The embodiments discussed herein are related to a communication device performing communication through an Internet Protocol (IP) network in accordance with a session control protocol.

### BACKGROUND

A session control protocol has been known that performs communication through an IP network. As an example of such a session control protocol, Session Initiation Protocol (SIP) or H.323 developed by International Telecommunication Union Telecommunication Standardization Sector (ITU-T) has been known.

In addition, a communication terminal has been known that performs voice call through a private branch exchange while performing thereon encoding according to the processing capacity of the exchange. In a first processing operation, with being triggered by being instructed to perform a voice call through no private branch exchange during the execution of the voice call, the communication terminal transmits, to a terminal on the other side, voice data indicating a predetermined voice pattern and the terminal identifier of the self-terminal. In a second processing operation, with being triggered by having received a response of the effect of accepting the switching of a communication form and a connection destination identifier indicating the connection destination of a communication session, the communication terminal establishes a communication session with the connection destination and resumes the transmission and reception of voice data. On the basis of a conversation with the call partner thereof, a user performing a voice call using the communication terminal understands that the terminal on the other side is compatible with a high sound quality call, and when reaching an agreement with the call partner on switching the communication form of the voice call to a form of passing through no IP-PBX20, the use presses down a high sound quality communication button provided in a communication terminal 10 and instructs to perform the switching thereof. Such a technique has been disclosed in Japanese Laid-open Patent Publication No. 2010-63060.

In the past, in a case of performing communication according to a session control protocol, even if not having been satisfied with, for example, communication quality, it has been difficult for a recipient of communication to switch a route through which an IP packet has gone, during communication.

### SUMMARY

According to an aspect of the invention, a communication device includes a storage device configured to store plural addresses assigned to the communication device; a user interface device, and a controller, wherein the controller executes processing that accepts an input of a user due to the user interface device, and address switching processing that causes a transmission destination address, used by an opposite device to transmit data to the communication device, to be switched to another address included in the plural addresses in accordance with the session control protocol, in response to the input.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of a first embodiment of a communication system;

FIGS. 2A and 2B are explanatory diagrams of examples of setting of a routing table;

FIG. 3 is a diagram illustrating an example of a hardware configuration of an IP telephone;

FIG. 4 is a functional block diagram of an example of an IP telephone;

FIGS. 5A and 5B are diagrams illustrating a first example of an address table;

FIG. 6 is an explanatory diagram of a first example of processing performed in an IP telephone at the time of INVITE message transmission;

FIG. 7 is an explanatory diagram of processing performed in an IP telephone at the time of UPDATE message transmission;

FIG. 8 is an explanatory diagram of processing performed in an IP telephone at the time of UPDATE message reception;

FIG. 9 is a diagram illustrating a first example of a message sequence;

FIG. 10 is an explanatory diagram of an example of a route of an IP packet;

FIG. 11 is a diagram illustrating a second example of the message sequence;

FIG. 12 is a diagram illustrating a third example of the message sequence;

FIGS. 13A and 13B are diagrams illustrating a second example of the address table;

FIG. 14 is an explanatory diagram of a second example of processing performed in the IP telephone at the time of INVITE message transmission;

FIG. 15 is a diagram illustrating a fourth example of the message sequence;

FIG. 16 is a diagram illustrating a fifth example of the message sequence;

FIG. 17 is a configuration diagram of a first embodiment of a communication system;

FIG. 18 is a diagram illustrating an example of a hardware configuration of a network control device;

FIG. 19 is a functional block diagram of an example of a network control device; and

FIG. 20 is an explanatory diagram of an example of generation processing for route information in a network control device.

### DESCRIPTION OF EMBODIMENTS

### 1. First Embodiment

### 1.1. Example of System Configuration

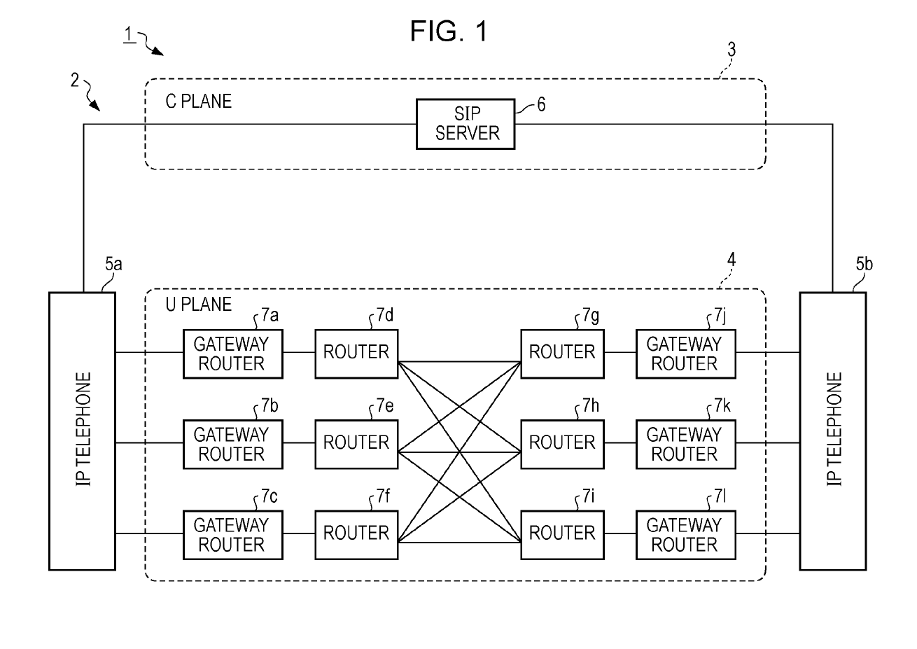

Hereinafter, a preferred embodiment will be described with reference to attached drawings. FIG. 1 is the configuration diagram of the first embodiment of a communication system. A communication system 1 includes a network 2 used for performing communication through an IP network in accordance with a predetermined session control program. A control message for controlling a session is transmitted through a control plane 3 of the network 2, and an IP packet for conveying user data is transmitted through a user plane 4 of the network 2. In the attached drawings, a control plane and a user plane are expressed as a “U-plane” and a “C-plane”, respectively.

Hereinafter, as an example of the communication system 1, an example of a communication system will be described where a telephone call is performed through an IP network in accordance with an SIP. In this regard, however, the following description does not intend to only apply the communication system described in the specification to a communication system controlling a session in accordance with an SIP. A device, a system, a computer program, and a session control method, described in the specification, may be widely applicable in a communication system performing communication through an IP network in accordance with a session control protocol where the transmission destination address of user data is able to be changed in the middle of a session.

The communication system 1 includes IP telephones 5a and 5b, an SIP server device 6, gateway routers 7a to 7c and 7j to 7l, and routers 7d to 7i. In the following description and accompanying drawings, the IP telephones 5a and 5b are collectively expressed as “IP telephones 5”, in some cases. In the following description and accompanying drawings, the SIP server device is occasionally expressed as an SIP server. In the following description and accompanying drawings, the gateway routers 7a to 7c and 7j to 7l are collectively expressed as “gateway routers 7”, in some cases. In the following description and accompanying drawings, the routers 7d to 7i are collectively expressed as “routers 7”, in some cases.

The IP telephone 5 is a communication device transmitting and receiving pieces of call data through the user plane 4 of the network 2 serving as an IP network. A plurality of IP addresses are assigned to each of the IP telephones 5a and 5b. For the sake of description, for example, a case is assumed where three addresses “aa:aa:aa:aa”, “bb:bb:bb:bb”, and “cc:cc:cc:cc” are assigned to the IP telephone 5a and three addresses “dd:dd:dd:dd”, “ee:ee:ee:ee”, and “ff:ff:ff:ff” are assigned to the IP telephone 5b.

The gateway router 7 and the router 7 perform route control for an IP packet conveying the call data of the IP telephone 5, transmitted on the user plane 4 of the network 2. In the following description and accompanying drawings, an IP packet conveying the call data of the IP telephone 5 is occasionally expressed as a “call packet”.

The gateway routers 7a to 7c are gateway routers to which the IP telephone 5a is connected. The gateway routers 7a to 7c are provided with respect to the individual addresses of the IP telephone 5a so that call packets having the plural addresses “aa:aa:aa:aa”, “bb:bb:bb:bb”, and “cc:cc:cc:cc” of the IP telephone 5a as destination addresses go therethrough. On the other hand, the gateway routers 7j to 7l are gateway routers to which the IP telephone 5b is connected. The gateway routers 7j to 7l are provided with respect to the individual addresses of the IP telephone 5b so that call packets having the plural addresses “dd:dd:dd:dd”, “ee:ee:ee:ee”, and “ff:ff:ff:ff” of the IP telephone 5b as destination addresses go therethrough.

Each router 7 holds a routing table serving as route information used for determining a router 7 serving as the subsequent transfer destination of a received call packet. The routing table specifies a router 7 serving as a transfer destination, with respect to each of the destination addresses of received packets. When having received a call packet, each router 7 determines a router 7 serving as a transfer destination, in accordance with a destination address and the routing table.

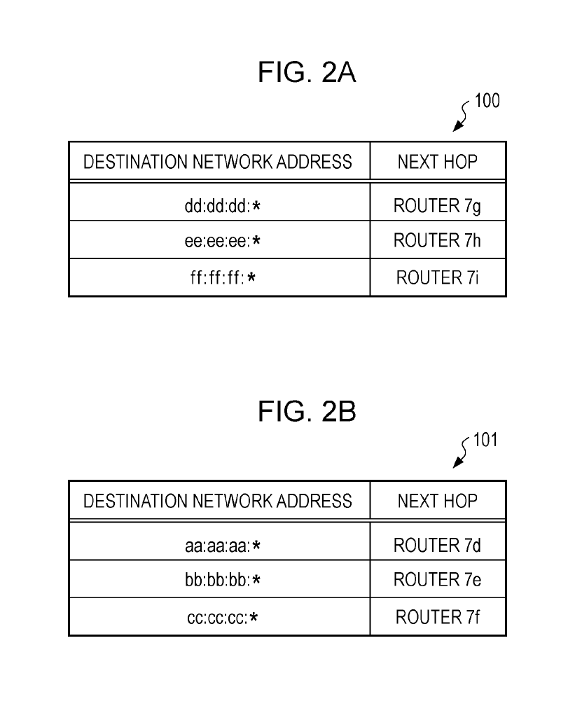

FIGS. 2A and 2B are the explanatory diagrams of examples of the setting of a routing table. The routing table has information elements “destination network address” and “next hop”. The information element “next hop” designates a router serving as a subsequent transfer destination to which a call packet of each destination network address designated by the information element “destination network address” is to be transferred.

FIG. 2A illustrates an example of a routing table 100, preliminarily set in each of the routers 7d to 7f and held by each of the routers 7d to 7f. The routing table 100 designates the different routers 7g to 7h as transfer destinations with respect to network addresses “dd:dd:dd:*”, “ee:ee:ee:*”, and “ff:ff:ff:*” to which the plural addresses “dd:dd:dd:dd”, “ee:ee:ee:ee”, and “ff:ff:ff:ff” of the IP telephone 5b belong. In other words, the routing table 100 designates the different routers 7g to 7h as transfer destinations with respect to the plural addresses “dd:dd:dd:dd”, “ee:ee:ee:ee”, and “ff:ff:ff:ff” of the IP telephone 5b. Call packets to the IP telephone 5b, whose destination addresses are these different addresses, are transmitted through different routes within the user plane 4.

In the example of the configuration in FIG. 1, the routers 7g to 7i are connected to the gateway routers 7j to 7l of the IP telephone 5b, respectively. For example, the routing tables 100 of the routers 7d to 7f adjacent to the routers 7g to 7i may individually designate, as the transfer destinations of packets having a plurality of addresses, the routers 7g to 7i connected to the gateway routers 7j to 7l individually corresponding to the plural addresses of the IP telephone 5b.

FIG. 2B illustrates an example of a routing table 101, preliminarily set in each of the routers 7g to 7i and held by each of the routers 7g to 7i. The routing table 101 designates the different routers 7d to 7f as transfer destinations with respect to network addresses “aa:aa:aa:*”, “bb:bb:bb:*”, and “cc:cc:cc:*” to which the plural addresses “aa:aa:aa:aa”, “bb:bb:bb:bb”, and “cc:cc:cc:cc” of the IP telephone 5a belong. Therefore, call packets to the IP telephone 5a, whose destination addresses are these different addresses, are transmitted through different routes within the user plane 4.

The IP telephone 5 transmits and receives SIP messages through the control plane 3 and the SIP server 6. The SIP server 6 performs management for the session information of a session due to the IP telephone 5 and control for an SIP transaction, and generates a response signal corresponding to a received SIP request.

### 1.2. Example of Hardware Configuration of IP Telephone

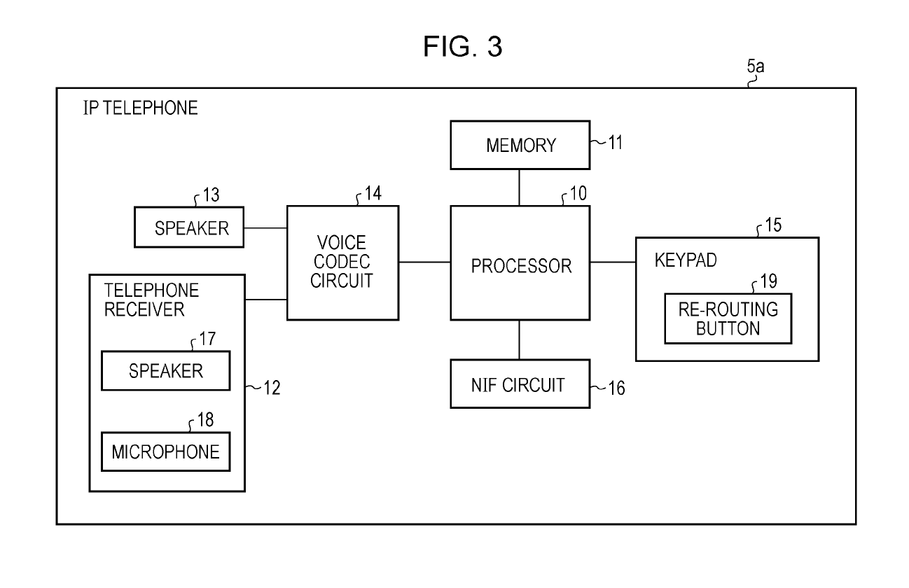

Next, the configuration of the IP telephone 5a will be described. FIG. 3 is a diagram illustrating an example of the hardware configuration of the IP telephone 5a. The other IP telephone 5b also has the same configuration. The hardware configuration illustrated in FIG. 3 is one of exemplifications of a hardware configuration realizing the IP telephone 5a. Any other hardware configuration may be adopted if the hardware configuration executes processing described hereinafter in the specification.

The IP telephone 5a includes a processor 10, a memory 11, a telephone receiver 12, a speaker 13, a voice codec circuit 14, a keypad 15, and a network interface circuit 16. In the attached drawings, a network interface is occasionally expressed as an “NIF”.

By executing a communication control program stored in the memory 11, the processor 10 performs session control processing according to the SIP and packet processing in each protocol layer. The memory 11 includes a non-volatile storage device for storing therein the communication control program and data used for the execution thereof. The non-volatile storage device may be, for example, a Read Only Memory (ROM), a flash memory, or a hard disk. In the memory 11, each piece of data and temporary data are stored that are used when the processor 10 executes the communication control program. The memory 11 may include a Random Access Memory (RAM).

The telephone receiver 12 is a handset or headset used for inputting and outputting voice signals due to the telephone call of the IP telephone 5a. The telephone receiver 12 includes a speaker 17 used for outputting a received voice and a microphone 18 used for inputting a voice to be transmitted. In addition, the received voice may be output from the speaker 13. The voice codec circuit 14 converts an analog voice signal detected by the microphone 18 into a digital signal and inputs the digital signal to the processor 10. In addition, the voice codec circuit 14 converts a digital voice signal output from the processor 10 into an analog signal and outputs the analog signal to the speaker 13 and/or the speaker 17. The voice codec circuit 14 may be a logic circuit such as a large scale integration (LSI), an Application Specific Integrated Circuit (ASIC), or a Field-Programming Gate Array (FPGA).

The keypad 15 is a user interface device used for inputting an operation performed on the IP telephone 5a. The keypad 15 includes, for example, a numerical keypad used for designating a call partner and dedicated buttons used for putting a telephone call on hold, an intra-office call, and an operation for an answering machine function. In the present embodiment, the keypad 15 includes a re-routing button 19 used for switching a route through which a call packet to be received goes. For example, when call quality is poor, the re-routing button 19 is used for switching a route through which a call packet to be received by a user of the IP telephone 5a goes and improving the call quality. The network interface circuit 16 is a communication interface circuit used for transmitting and receiving IP packets going through the control plane 3 and the user plane 4 of the network 2.

### 1.3. Example of Functional Configuration of IP Telephone

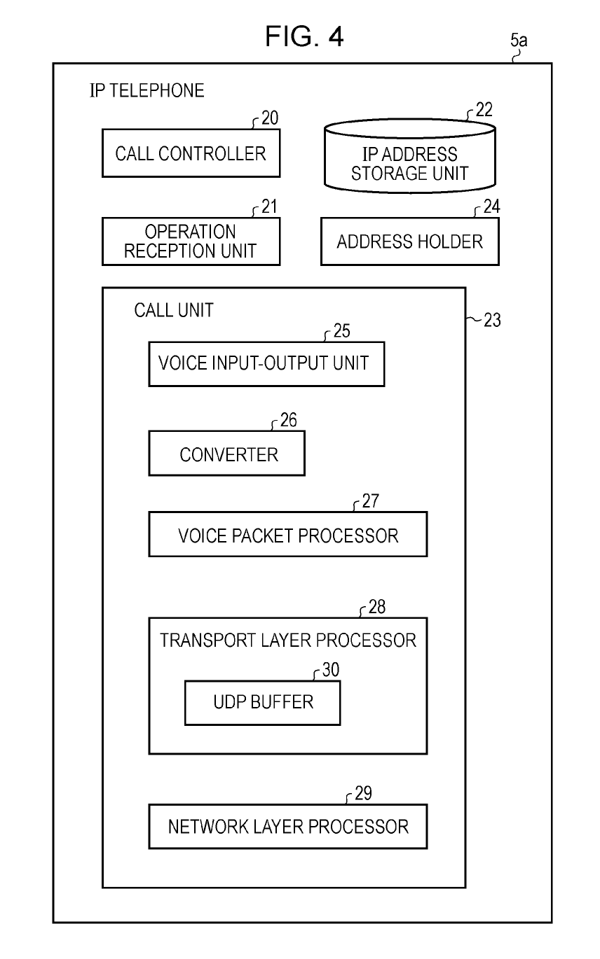

Next, the function of the IP telephone 5a will be described that is realized by the above-mentioned hardware configuration. FIG. 4 is the functional block diagram of an example of the IP telephone 5a. The other IP telephone 5b also has the same configuration. In addition, FIG. 4 illustrates functions relating to the following description with a central focus thereon. The IP telephone 5a may include another configuration element other than the illustrated configuration elements.

The IP telephone 5a includes a call controller 20, an operation reception unit 21, an IP address storage unit 22, a call unit 23, and an address holder 24. For the sake of description, it is assumed that an opposite device engaged in a telephone call with the IP telephone 5a is the IP telephone 5b.

The call controller 20 controls the session of a telephone call due to the IP telephone 5a, in accordance with the SIP. The operation reception unit 21 accepts inputting of an operation to the IP telephone 5a, due to the keypad. When the operation reception unit 21 has accepted the pressing-down operation of the re-routing button 19 during a telephone call with the IP telephone 5b, the call controller 20 performs address switching processing for causing the IP telephone 5b to switch the destination address of a call packet to be transmitted to the IP telephone 5a, in accordance with a procedure defined by the SIP.

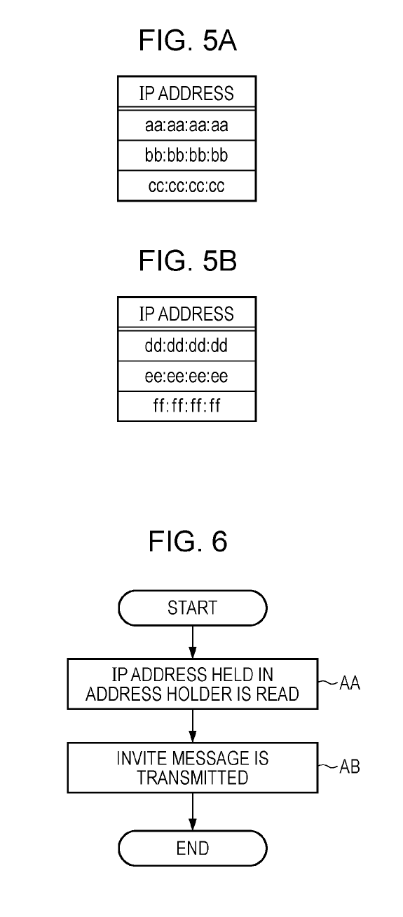

At this time, the call controller 20 selects one address other than a currently used address, from among the plural addresses “aa:aa:aa:aa”, “bb:bb:bb:bb”, and “cc:cc:cc:cc” assigned to the IP telephone 5a. In the IP address storage unit 22, an address table is stored in which the plural addresses assigned to the IP telephone 5a are registered. FIG. 5A and FIG. 5B illustrate address tables stored in the IP address storage units 22 of the IP telephones 5a and 5b, respectively.

The call controller 20 selects one address registered in the address table using a round-robin method. In another embodiment, the call controller 20 may also randomly select one address from among addresses registered in the address table. In another embodiment, the call controller 20 may also select one address in accordance with a priority order defined for each address registered in the address table. The call controller 20 causes the destination address of a call packet to the IP telephone 5a to be switched to a selected address.

A procedure causing the IP telephone 5b to switch the destination address of a call packet may be, for example, an UPDATE method. The UPDATE method is a procedure for updating the parameter of a session without influence on the state of a dialogue. By designating a new destination address in a row of the body of the UPDATE message in accordance with a Session Description Protocol (SDP), the row beginning with “c=”, it may be possible to switch the destination address of a call packet. In the following description, a row of a message body, which begins with “c=”, is occasionally expressed as “c=row”.

When having caused the IP telephone 5b to switch the destination address of a call packet to a new address, the call controller 20 changes the source address of a call packet to be transmitted thereafter to a new address.

When transmitting a session establishment request message, the call controller 20 designates an address held in the address holder 24, as the destination address of a call packet to be transmitted to the IP telephone 5a. In addition, when transmitting a response message corresponding to a session establishment request message, the call controller 20 designates an address held in the address holder 24, as the destination address of a call packet to be transmitted to the IP telephone 5a. As a result, a destination address used in a final session previously performed is designated as the destination address of a call packet to the IP telephone 5a, at the time of session establishment.

The call unit 23 performs processing for a call packet. The call unit 23 includes a voice input-output unit 25, a converter 26, a voice packet processor 27, a transport layer processor 28, and a network layer processor 29.

At the time of transmitting a call packet, the voice input-output unit 25 inputs a voice signal of a call voice. The converter 26 converts the voice signal input by the voice input-output unit 25 into a digital signal. The voice packet processor 27 converts the voice signal in digital format into a Real-time Transport Protocol (RTP) packet. The transport layer processor 28 converts the RTP packet into a User Datagram Protocol (UDP) packet. The network layer processor 29 converts the UDP packet into an IP packet, and designates the address of the IP telephone 5b at the other end as a destination address in a header. The network layer processor 29 transmits the IP packet to the user plane 4 through the network interface circuit 16.

At the time of receiving a call packet, the network layer processor 29 receives the call packet from the user plane 4 through the network interface circuit 16. The network layer processor 29 converts the call packet into a UDP packet. Regardless of a destination address designated by the call packet, the network layer processor 29 stores an RTP packet serving as the payload of the UDP packet, in a UDP buffer 30 in the transport layer processor 28.

The voice packet processor 27 acquires each payload of the RTP packet stored in the UDP buffer 30 in order of the sequence number of the RTP packet, and outputs the payload to the converter 26. The converter 26 converts the digital signal of a call signal serving as an RTP payload into an analog signal. The voice input-output unit 25 outputs the voice signal of a call voice.

As described above, in the reception processing for the call packet, even if the destination address of the IP telephone 5a changes that has been designated by the call packet, the RTP packet is processed in order of the sequence number of the RTP packet, regardless of the destination address. Accordingly, even if, owing to the UPDATE request message, the IP telephone 5b switches the destination address of a call packet to be transmitted to the IP telephone 5a, a voice output from the voice input-output unit 25 is not discontinued. Therefore, the discontinuance of service due to the switching of the destination address does not occur.

In addition, the operations of the call controller 20, the voice packet processor 27, the transport layer processor 28, and the network layer processor 29 are performed by the processor 10 illustrated in FIG. 3. In addition, a signal occurring owing to an operation performed on the keypad 15 is received by the processor 10, and hence, the above-mentioned operation of the operation reception unit 21 is performed. As the voice input-output unit 25, the speaker 13 and/or the speaker 17 outputs a voice signal. As the voice input-output unit 25, the microphone 18 inputs a voice signal. The above-mentioned operation in the converter 26 is performed by the voice codec circuit 14. The memory 11 is used as the IP address storage unit 22, the address holder 24, and the UDP buffer 30, and data stored therein is stored within the memory 11.

### 1.4. Description of Operation of IP Telephone

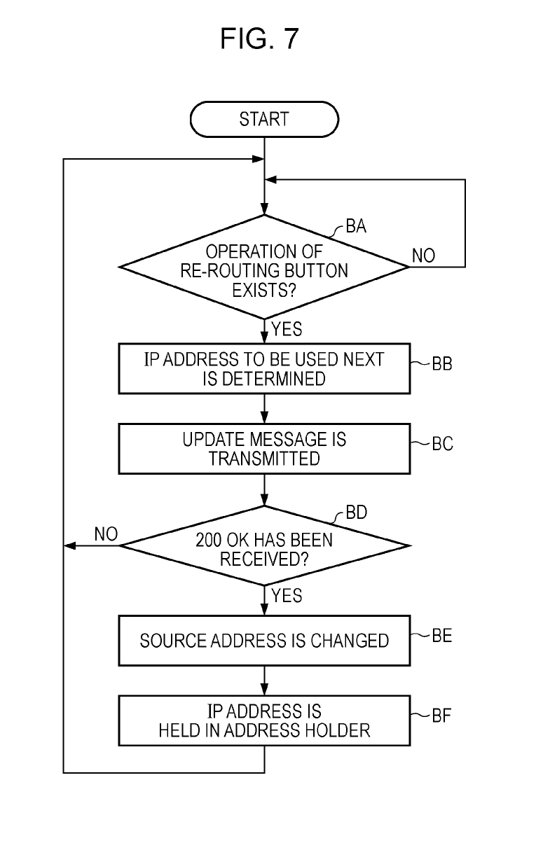

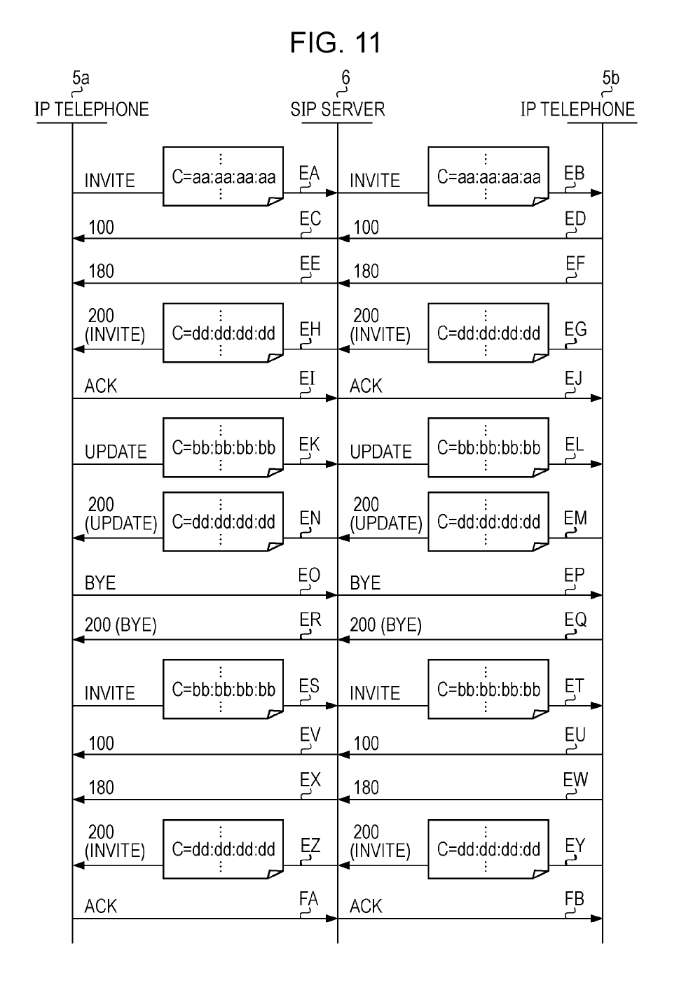

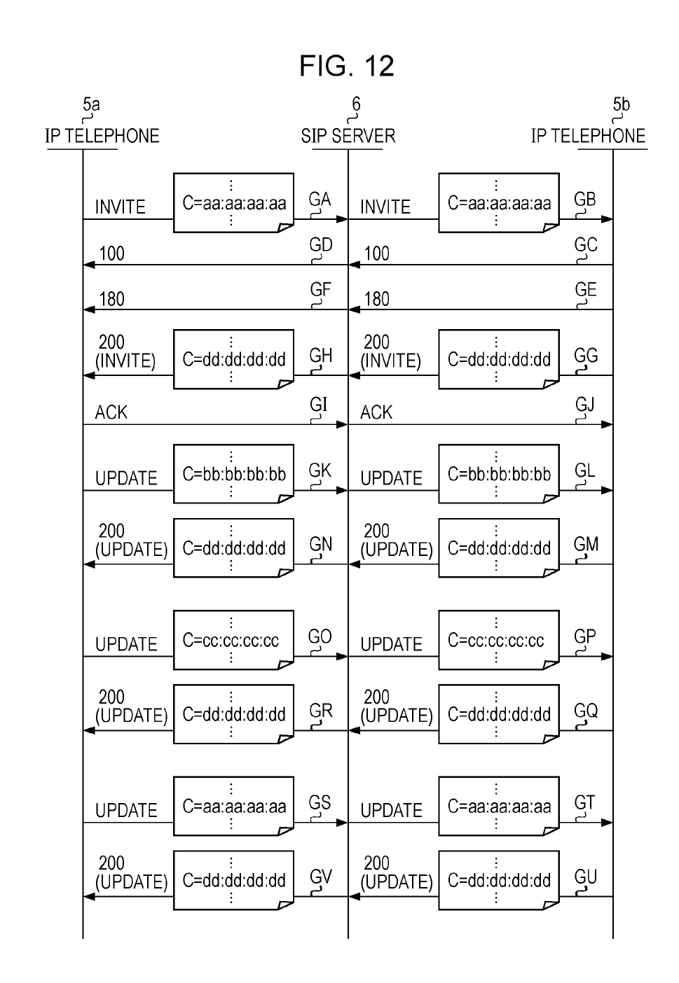

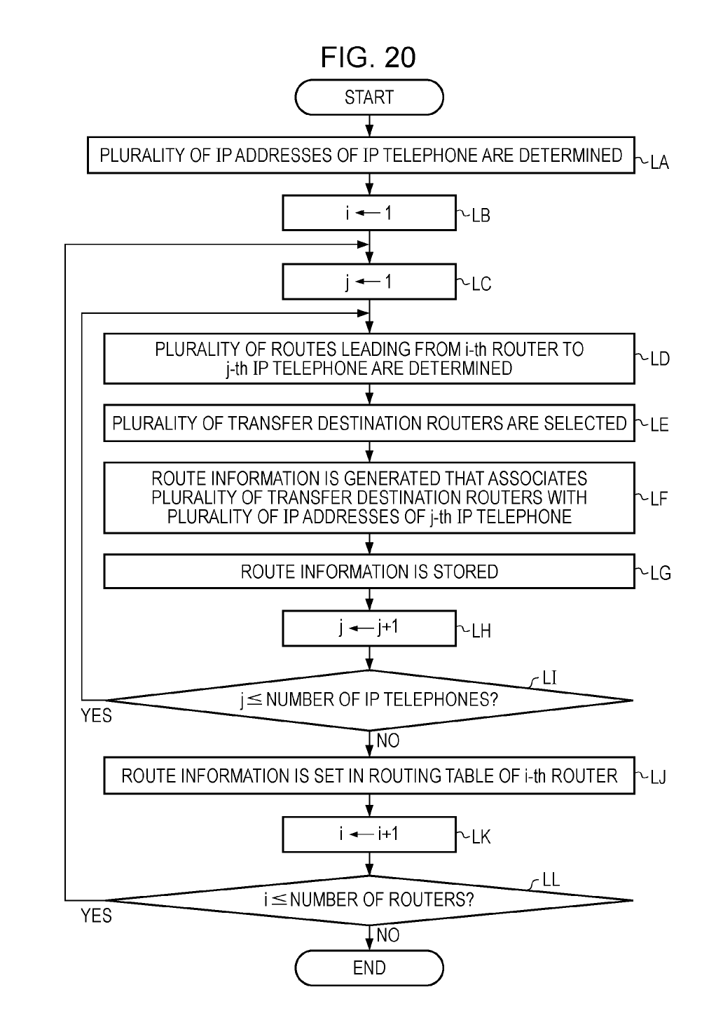

Next, the operation of the IP telephone 5a will be described. FIG. 6 is the explanatory diagram of the first example of processing performed when the IP telephone 5a transmits an INVITE message serving as a session establishment request message and establishes a session. In addition, hereinafter, a sequence of operations described with reference to FIG. 6 may be construed as a method including a plurality of procedures. In this case, an “operation” may be read as a “step”. The same applies to the cases of FIG. 7 to FIG. 9, FIG. 11, FIG. 12, FIG. 14 to FIG. 16, and FIG. 20.

In an operation AA, the call controller 20 reads an address held in the address holder 24. The call controller 20 designates the read address as the destination address of a call packet to the IP telephone 5a, in the “c=row” of the body of an INVITE message. In an operation AB, the call controller 20 transmits the INVITE message to the IP telephone 5b through the SIP server 6. Owing to this processing, a destination address where a call packet is transmitted from the IP telephone 5b to the IP telephone 5a turns out to be an address last used by the IP telephone 5a.

Next, processing will be described that is used for causing the IP telephone 5b to change a destination address where a call packet is transmitted to the IP telephone 5a. FIG. 7 is the explanatory diagram of processing performed in the IP telephone 5a at the time of UPDATE message transmission. In an operation BA, the call controller 20 determines whether or not the pressing-down operation of the re-routing button 19 exists. When the pressing-down operation of the re-routing button 19 does exist (operation BA: N), the operation BA is repeated. When the pressing-down operation of the re-routing button 19 exists (operation BA: Y), the processing proceeds to an operation BB.

In the operation BB, the call controller 20 selects one address other than a currently used address, from among addresses registered in the address table stored in the IP address storage unit 22. The call controller 20 designates the selected address, in the “c=row” of the body of an UPDATE message. In an operation BC, the call controller 20 transmits the UPDATE message to the IP telephone 5b through the SIP server 6.

In an operation BD, the call controller 20 determines whether or not a 200 OK response message serving as a response message corresponding to the UPDATE message has been received. When the 200 OK response message has been received (operation BD: Y), the processing proceeds to an operation BE. As a result, a destination address where the IP telephone 5b transmits a call packet to the IP telephone 5a is changed.

In the operation BE, the call controller 20 changes, to the address determined in the operation BB, an address used as the source address of a call packet to be transmitted to the IP telephone 5b. In an operation BF, the call controller 20 holds the address determined in the operation BB, in the address holder 24. After that, the processing returns to the operation BA.

On the other hand, when, in the operation BD, it is determined that the 200 OK response message has not been received (operation BD: N), the processing returns to the operation BA without changing the address used as the source address of the call packet.

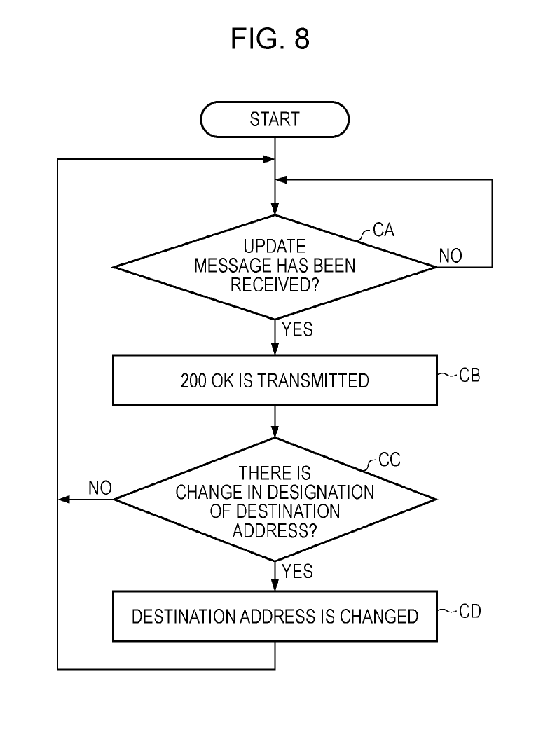

FIG. 8 is the explanatory diagram of processing performed in the IP telephone 5b having received an UPDATE message. In an operation CA, the call controller 20 determines whether or not an UPDATE message has been received from the IP telephone 5a engaged in a telephone call. When the UPDATE message has not been received (operation CA: N), the processing returns to the operation CA. When the UPDATE message has been received (operation CA: Y), the processing proceeds to an operation CB.

In the operation CB, the call controller 20 transmits a 200 OK response message corresponding to the UPDATE message to the IP telephone 5a. In an operation CC, the call controller 20 determines whether or not there is a change in the designation of the destination address of the IP telephone 5a in the “c=row” of the UPDATE message. When there is the change (operation CC: Y), the processing proceeds to an operation CD.

In the operation CD, the call controller 20 changes, to an address designated by the UPDATE message, an address used as the destination address of a call packet to be transmitted to the IP telephone 5a. After that, the processing returns to the operation CA. On the other hand, when, in the operation CC, it is determined that there is no change in the designation of the destination address of the IP telephone 5a (operation CC: N), the processing returns to the operation CA without changing the address used as the destination address of the call packet.

### 1.5. Message Sequence

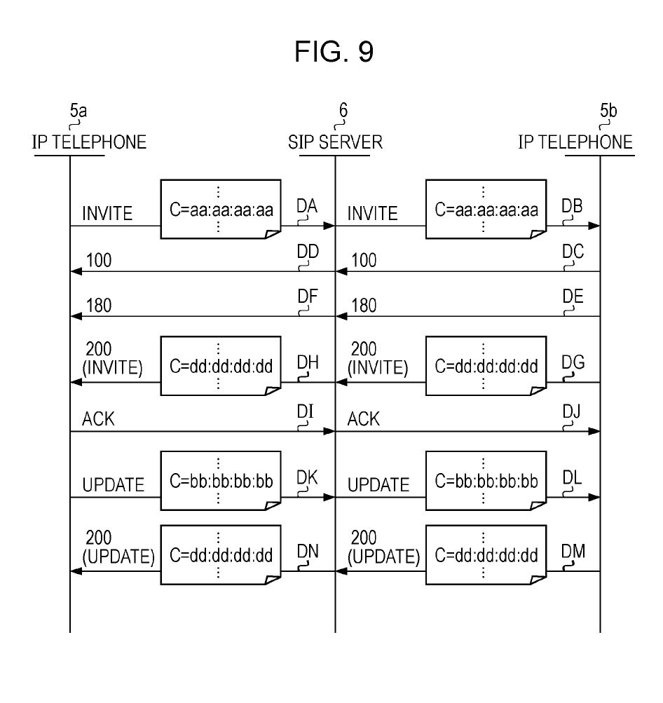

Next, the sequence of an SIP message occurring owing to the above-mentioned operation of the IP telephone 5 will be described. FIG. 9 is a diagram illustrating the first example of a message sequence. In the following description, it is assumed that “aa:aa:aa:aa” and “dd:dd:dd:dd” are stored in the address holders 24 in the IP telephones 5a and 5b, as destination addresses previously used by the IP telephones 5a and 5b, respectively. The same applies to sequences in FIG. 11 and FIG. 12.

In an operation DA, the IP telephone 5a transmits, to the SIP server 6, an INVITE message used for establishing a session with the IP telephone 5b. In the “c=row” thereof, “aa:aa:aa:aa” stored in the address holder 24 is designated. In an operation DB, the SIP server 6 transmits the INVITE message to the IP telephone 5b.

In an operation DC, the IP telephone 5b transmits, to the SIP server 6, a 100 Trying message serving as a temporary response message corresponding to the INVITE message.

In an operation DD, the SIP server 6 transmits the 100 Trying message to the IP telephone 5a. In an operation DE, the IP telephone 5b transmits, to the SIP server 6, a 180 Ringing message giving notice of currently reading. In an operation DF, the SIP server 6 transmits the 180 Ringing message to the IP telephone 5a.

In an operation DG, the IP telephone 5b transmits, to the SIP server 6, a 200 OK message corresponding to the INVITE message. In the “c=row” of the 200 OK message, “dd:dd:dd:dd” stored in the address holder 24 is designated. In an operation DH, the SIP server 6 transmits the 200 OK message to the IP telephone 5a. In an operation DI, the IP telephone 5a transmits, to the SIP server 6, an ACK message serving as a confirmation response message corresponding to the 200 OK message. In an operation DJ, the SIP server 6 transmits the ACK message to the IP telephone 5b.

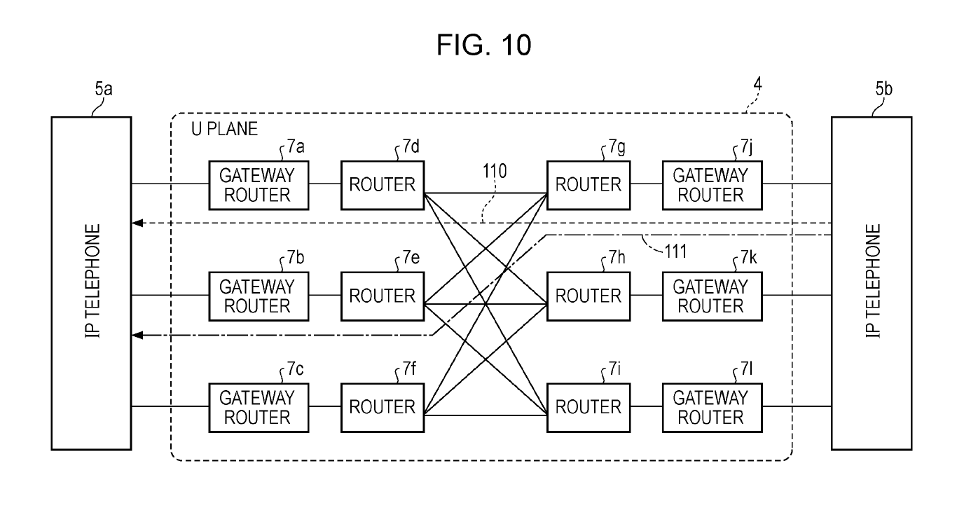

Owing to the above-mentioned operation, “dd:dd:dd:dd” is designated as the destination address of a call packet from the IP telephone 5a to the IP telephone 5b, and “aa:aa:aa:aa” is designated as the destination address of a call packet from the IP telephone 5b to the IP telephone 5a. FIG. 10 illustrates a route through which a call packet from the IP telephone 5b to the IP telephone 5a goes.

As described with reference to FIG. 2B, the routing tables in the routers 7g to 7h designate the router 7d as the transfer destination of a call packet whose destination network address is “aa:aa:aa:*”. Accordingly, when the IP telephone 5b has transmitted a call packet from the gateway router 7j corresponding to the address “dd:dd:dd:dd”, the call packet is transmitted to the IP telephone 5a through a route indicated by a dashed line 110. The route 110 goes through the gateway router 7j, the routers 7g and 7d, and the gateway router 7a.

FIG. 9 is referred to. A user of the IP telephone 5a, not satisfied with communication quality, presses down the re-routing button 19 so as to try to improve the call quality by changing a route through which a call packet to be received goes. When the re-routing button 19 has been pressed down, the IP telephone 5a transmits an UPDATE message to the SIP server 6, in an operation DK. At this time, the IP telephone 5a determines an address to be designated in the “c=row” of the UPDATE message using a round-robin method. In the example, the address “bb:bb:bb:bb” is designated in the “c=row” of the UPDATE message. The IP telephone 5a stores the address “bb:bb:bb:bb” in the address holder 24.

In an operation DL, the SIP server 6 transmits the UPDATE message to the IP telephone 5b. In an operation DM, the IP telephone 5b transmits a 200 OK message corresponding to the UPDATE message to the SIP server 6. In an operation DN, the SIP server 6 transmits the 200 OK message to the IP telephone 5a. Owing to this operation, the destination address of a call packet from the IP telephone 5b to the IP telephone 5a is changed to “bb:bb:bb:bb”.

In FIG. 10, the route of the call packet after the change is indicated by a dashed-dotted line 111. As described with reference to FIG. 2B, the routing tables in the routers 7g to 7h designate the router 7e as the transfer destination of a call packet whose destination network address is “bb:bb:bb:*”. Accordingly, when the IP telephone 5b has transmitted a call packet from the gateway router 7j, the call packet goes through the gateway router 7j, the routers 7g and 7e, and the gateway router 7b. In such a way as described above, the route through which the call packet goes is switched.

Next, an example of a message sequence will be described that occurs when a session is established after the termination of a session in which a destination address has been changed. FIG. 11 is a diagram illustrating the second example of the message sequence. Operations in operations EA to EN are the same as the operations in the operations DA to DN illustrated in FIG. 9.

In an operation EO, the IP telephone 5a transmits, to the SIP server 6, a BYE message serving as a call termination request message. In an operation EP, the SIP server 6 transmits the BYE message to the IP telephone 5b. In an operation EQ, the IP telephone 5b transmits, to the SIP server 6, a 200 OK message corresponding to the BYE message. In an operation ER, the SIP server 6 transmits the 200 OK message to the IP telephone 5a. With that, an telephone call between the IP telephones 5a and 5b is terminated.

After that, in an operation ES, the IP telephone 5a transmits, to the SIP server 6, an INVITE message used for establishing a session with the IP telephone 5b. In the “c=row” thereof, a last-used destination address “bb:bb:bb:bb” stored in the address holder 24 is designated. In an operation ET, the SIP server 6 transmits the INVITE message to the IP telephone 5b. Operations in operations EU to FB are the same as the operations in the operations ED to EJ.

Owing to the above-mentioned operation, the address last used in a previous telephone call is used as a destination address at the time of establishment of a session. As described with reference to FIG. 9, by switching a destination address in response to pressing down the re-routing button 19, it may be possible for a user to change a route through which a call packet to the IP telephone 5a goes. Accordingly, it may be possible for the user not satisfied with, for example, call quality to try to improve the call quality. Here, it may be highly probable that a destination address used to the last in a previous session has been used in a state where the user has been satisfied with the call quality. Accordingly, by designating, as a destination address, a destination address last used in a previous session, at the time of establishment of a session, it may be possible to enhance a probability that a call packet is transmitted through a route capable of performing relatively high-quality communication.

Next, an example of a message sequence will be described that occurs when the re-routing button 19 is continuously pressed down. FIG. 12 is a diagram illustrating the third example of the message sequence. Operations in operations GA to GN are the same as the operations in operations DA to DN illustrated in FIG. 9.

In response to pressing down again the re-routing button 19, in an operation GO, the IP telephone 5a transmits an UPDATE message to the SIP server 6. Using a round-robin method, the IP telephone 5a sets the address “cc:cc:cc:cc”, as an address designated in the “c=row” of the UPDATE message. The IP telephone 5a stores the address “cc:cc:cc:cc” in the address holder 24. Operations in operations GP to GR are the same as the operations in the operations GL to GN.

In response to pressing down again the re-routing button 19, in an operation GS, the IP telephone 5a transmits an UPDATE message to the SIP server 6. Using the round-robin method, the IP telephone 5a sets the address “aa:aa:aa:aa”, as an address designated in the “c=row” of the UPDATE message. The IP telephone 5a stores the address “aa:aa:aa:aa” in the address holder 24. Operations in operations GT to GV are the same as the operations in the operations GL to GN. In this way, when the re-routing button 19 has been pressed down, the IP telephone 5a sequentially selects one address from among a plurality of addresses stored in the IP address storage unit 22, using the round-robin method, and designates the address as the destination address of the IP telephone 5a.

### 1.6. Advantageous Effects

According to the present embodiment, it may be possible for a user of the IP telephone 5 to switch, during a telephone call, a route through which a call packet received by the IP telephone 5 goes. Therefore, it may be possible for the user to select a high-call-quality route through which a call packet goes. In addition, as described in the above-mentioned “1.3. Example of Functional Configuration of IP Telephone”, even if an destination address is switched so as to switch a route through which a call packet goes, the output voice of the IP telephone 5 is not discontinued. Therefore, according to the present embodiment, it may be possible to switch a route through which a call packet goes, without the discontinuance of service occurring.

In addition, a button used by the user for instructing to switch a route through which a call packet goes may also double as a button for another function. For example, the call controller 20 may also transmit an UPDATE message in response to simultaneously pressing down a plurality of buttons for other functions. In addition, for example, the call controller 20 may also transmit an UPDATE message in response to pressing down a plurality of buttons for other functions in a predetermined sequence. In addition, a user interface where the user instructs to switch a route through which a call packet goes may also be another type other than the button.

### 2. Second Embodiment

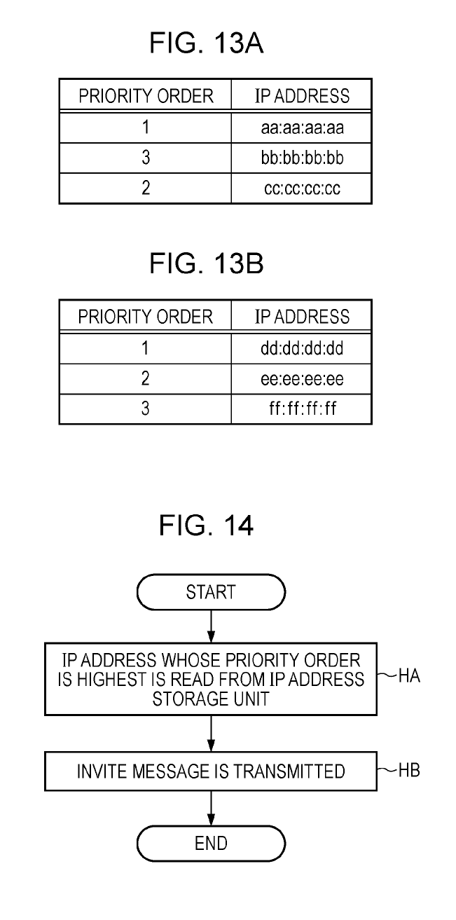

Next, another embodiment will be described. In the present embodiment, priority orders are assigned to a plurality of addresses assigned to the IP telephone 5, and a destination address where a call packet is transmitted to the IP telephone 5 is designated in accordance with this priority order. FIGS. 13A and 13B are diagrams illustrating examples of address tables stored in the IP address storage units 22 in the IP telephones 5a and 5b, respectively. The address table includes information elements “priority order” and “IP address”.

The information element “IP address” indicates an address assigned to each IP telephone 5. The information element “priority order” indicates the priority order of each address. For example, the priority orders of a plurality of addresses “aa:aa:aa:aa”, “bb:bb:bb:bb”, and “cc:cc:cc:cc” illustrated in FIG. 13A and assigned to the IP telephone 5a correspond to the first place, the third place, and the second place, respectively. The priority orders of a plurality of addresses “dd:dd:dd:dd”, “ee:ee:ee:ee”, and “ff:ff:ff:ff” illustrated in FIG. 13B and assigned to the IP telephone 5b correspond to the first place, the second place, and the third place, respectively.

When transmitting an INVITE message, the response message thereof, or an UPDATE message, the call controller 20 designates the destination address of a call packet to be transmitted to the IP telephone 5a in accordance with the priority order. For example, in the INVITE message or the response message thereof, the call controller 20 designates an address whose priority order is the highest. In addition, in the UPDATE message, the call controller 20 designates an address whose priority order is next to a currently used address.

For example, FIG. 14 is the explanatory diagram of the second example of processing performed in the IP telephone 5 at the time of INVITE message transmission. In an operation HA, the call controller 20 reads an address whose priority order is the highest among a plurality of addresses stored in the IP address storage unit 22. The call controller 20 designates the read address as the destination address of a call packet to the IP telephone 5a, in the “c=row” of the body of the INVITE message. In an operation HB, the call controller 20 transmits the INVITE message to the IP telephone 5b through the SIP server 6.

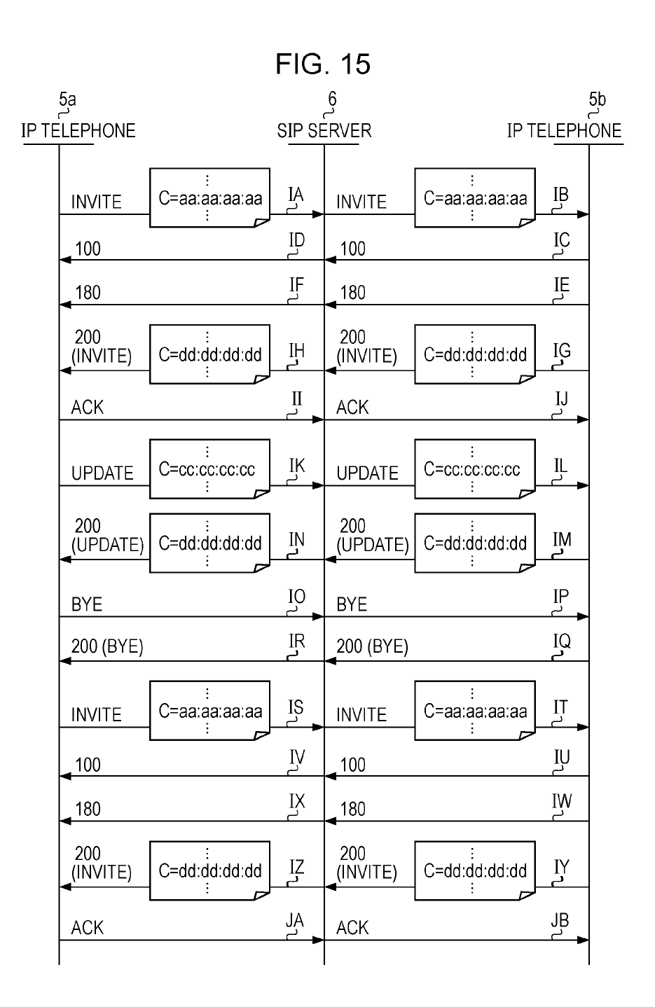

Next, the sequence of an SIP message will be described that occurs in the present embodiment. FIG. 15 illustrates an example of a message sequence occurring when a session is established after the termination of a session whose destination address has been changed. In an operation IA, the IP telephone 5a transmits, to the SIP server 6, an INVITE message used for establishing a session with the IP telephone 5b. In the “c=row” thereof, the address “aa:aa:aa:aa” is designated whose priority order is the highest among the plural addresses stored in the IP address storage unit 22. Operations in operations IB to IJ are the same as the operations in the operations EB to EJ illustrated in FIG. 11.

When the re-routing button 19 has been pressed down, the IP telephone 5a transmits an UPDATE message to the SIP server 6, in an operation IK. At this time, the IP telephone 5a designates the address “cc:cc:cc:cc” whose priority order is next to a currently used address, in the “c=row” of the UPDATE message. Operations in operations IL to IR are the same as the operations in the operations EL to ER illustrated in FIG. 11.

After that, in an operation IS, the IP telephone 5a transmits, to the SIP server 6, an INVITE message used for establishing a session with the IP telephone 5b. The address “aa:aa:aa:aa” is designated whose priority order is the highest among the plural addresses stored in the IP address storage unit 22. In an operation IT, the SIP server 6 transmits the INVITE message to the IP telephone 5b. Operations in operations IU to JB are the same as the operations in the operations IC to IJ.

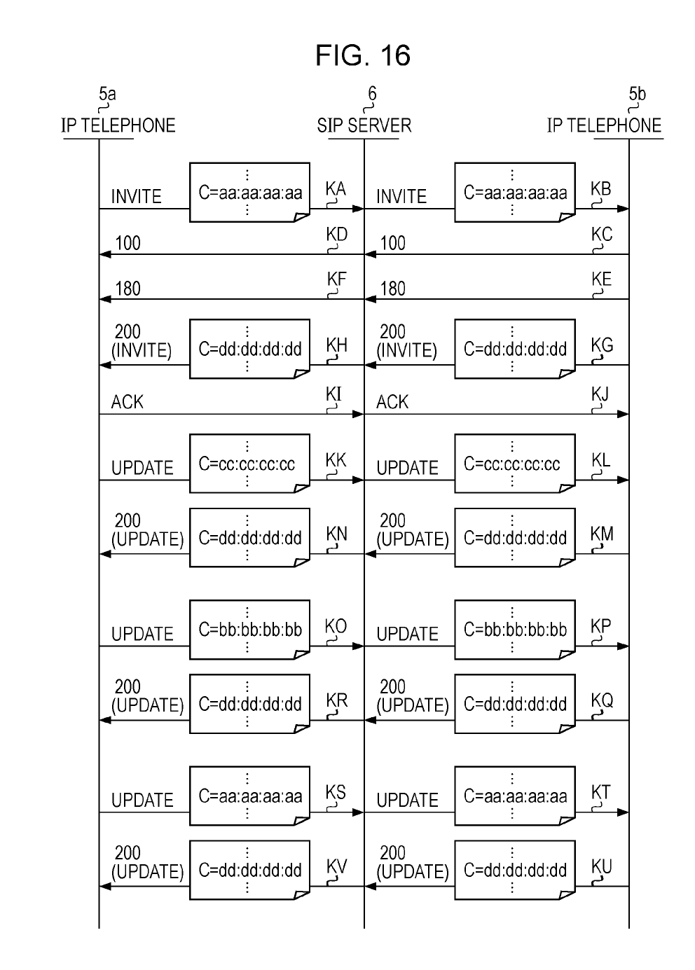

FIG. 16 illustrates an example of a message sequence occurring when the re-routing button 19 is continuously pressed down. Operations in operations KA to KN are the same as the operations in the operations IA to IN illustrated in FIG. 15.

In response to pressing down again the re-routing button 19, in an operation KO, the IP telephone 5a transmits an UPDATE message to the SIP server 6. The IP telephone 5a designates the address “bb:bb:bb:bb” whose priority order is next to a currently used address, in the “c=row” of the UPDATE message. Operations in operations KP to KR are the same as the operations in the operations KL to KN.

In response to pressing down again the re-routing button 19, in an operation KS, the IP telephone 5a transmits an UPDATE message to the SIP server 6. Since the priority order of a current destination address is the lowest, the IP telephone 5a designates the address “aa:aa:aa:aa” whose priority order is the highest, in the “c=row” of the UPDATE message. Operations in operations KT to KV are the same as the operations in the operations KL to KN.

According to the present embodiment, it may be possible to arbitrarily set the usage sequence of the destination address of the IP telephone 5a. Therefore, for example, the usage frequency of a destination address where a telephone call has been able to be made with high communication quality is enhanced on the basis of past experience, and hence, it may be possible to try to improve communication quality.

### 3. Third Embodiment

### 3.1. Example of System Configuration

Next, another embodiment will be described. In the communication system 1 of the present embodiment, using a network control device performing monitoring processing and control processing for the network 2, the setting of a plurality of addresses of the IP telephone 5 and the setting of the route information of each router 7 are performed. Owing to the setting processing utilizing the network control device, the plural addresses and the route information are set so that call packets addressed to a plurality of addresses of each IP telephone 5 pass through different routes in the same way as the above-mentioned embodiment.

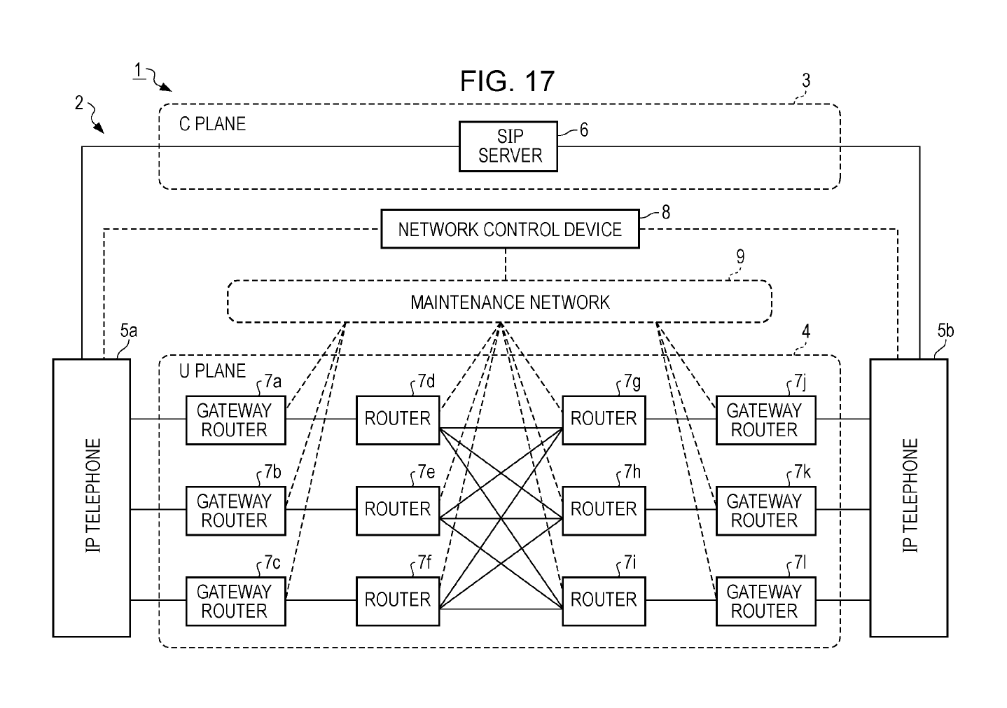

FIG. 17 is the configuration diagram of the first embodiment of the communication system 1. The communication system 1 includes a network control device 8 and a maintenance network 9. The network control device 8 determines a plurality of addresses assigned to each IP telephone 5, and registers the plural addresses in the address table stored in the IP address storage unit 22 of the IP telephone 5, owing to communication through the user plane 4. In addition, owing to communication with the gateway router 7 and the router 7 through the maintenance network 9, the network control device 8 sets route information held by these routers.

### 3.2. Example of Configuration of Network Management Device

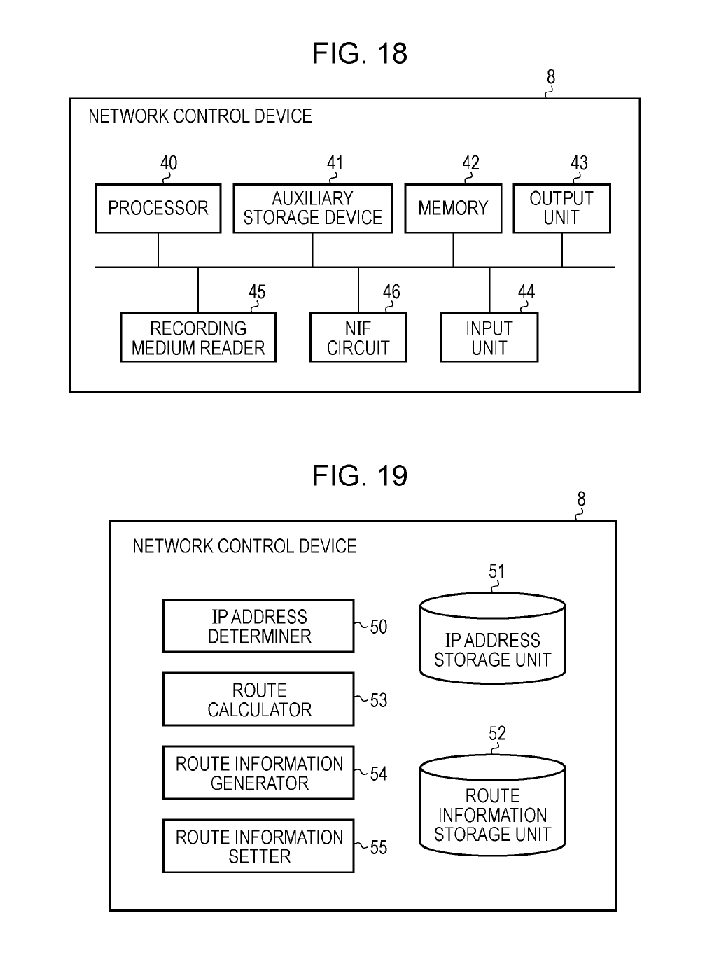

FIG. 18 is a diagram illustrating an example of the hardware configuration of the network control device 8. The hardware configuration illustrated in FIG. 18 is one of exemplifications of a hardware configuration realizing the network control device 8. Any other hardware configuration may be adopted if the hardware configuration executes processing described hereinafter in the specification. The network control device 8 includes a processor 40, an auxiliary storage device 41, a memory 42, an output unit 43, an input unit 44, a recording medium reader 45, and a network interface circuit 46.

The processor 40 performs monitoring processing and control processing for the network 2. In the auxiliary storage device 41, a network control program is stored that causes the processor 40 to execute these processing operations.

The auxiliary storage device 41 includes a non-volatile storage device for storing therein a computer program and data used for the execution thereof. The non-volatile storage device may be, for example, a Read Only Memory, a flash memory, or a hard disk. In the memory 42, each piece of data and temporary data are stored that are used when the processor 40 executes the computer program. The memory 42 may include a Random Access Memory.

The output unit 43 is an output device used for presenting information from the network control device 8 to the maintenance person of the communication system 1. For example, the output unit 43 may be a display device visually displaying information to the maintenance person. The output unit 43 may be a display device such as a light-emitting element, a liquid crystal display, or an organic electroluminescence display. In addition, the output unit 43 may be a speaker outputting a voice signal or the drive circuit thereof. The input unit 44 is an input device accepting an input operation due to a user. The input unit 44 may be, for example, a button, a scroll wheel, a keypad, a keyboard, a pointing device, a touch panel, or the like.

The recording medium reader 45 reads data stored in a computer-readable portable recording medium. The recording medium reader 45 may be, for example, a Compact Disc (CD)-ROM drive device, a Digital Versatile Disk (DVD)-ROM drive device, a flexible disk drive device, or a Compact Disc Recordable (CD-R) drive device. The recording medium reader 45 may also be a Digital Versatile Disk Recordable (DVD-R) drive device, a Magneto-Optical disk (MO) drive device, a device accessing a flash memory device. In an embodiment, a route setting program used for causing the processor 40 to execute route setting processing to be described below is stored in computer-readable portable recording media and distributed. The route setting program is read from the portable recording medium by the recording medium reader 45, and installed into the auxiliary storage device 41.

The network interface circuit 46 is a communication interface circuit used for transmitting and receiving IP packets going through the control plane 3 and the user plane 4 of the network 2 and the maintenance network 9.

In an embodiment, by operating the input unit 44, the maintenance person of the communication system 1 may perform the setting of the plural addresses of the IP telephone 5 and the setting of the route information of the gateway router 7 and the router 7. In another embodiment, the network control device 8 may automatically execute route setting processing for setting the address information of the IP telephone 5 and the route information of the gateway router 7 and the router 7. In this case, in the auxiliary storage device 11, the route setting program is stored that is used for causing the processor 40 to execute the route setting processing. Hereinafter, an embodiment will be described where the processor 40 executes the route setting processing.

FIG. 19 is the functional block diagram of an example of the network control device 8. In addition, FIG. 19 illustrates functions relating to the following description with a central focus thereon. The network control device 8 may include another configuration element other than the illustrated configuration elements. The network control device 8 includes an IP address determiner 50, an IP address storage unit 51, a route information storage unit 52, a route calculator 53, a route information generator 54, and a route information setter 55.

With respect to each IP telephone 5, the IP address determiner 50 determines a plurality of addresses to be assigned to each IP telephone 5. The determined addresses of the IP telephone 5 are stored in the IP address storage unit 51. In the route information storage unit 52, route information is stored that is set in the routing tables in the gateway router 7 and the router 7 so as to transfer a call packet.

When the route information is determined, the route calculator 53 calculates a plurality of routes leading from each router 7 to each IP telephone 5. On the basis of the calculation result of the route calculator 53, the route information generator 54 generates route information where each router 7 designates the transfer destination of a call packet. In this case, on the basis of the plural routes calculated with respect to each IP telephone 5, the route information generator 54 determines a plurality of subsequent transfer destination routers used for transmitting a call packet from each router 7 to the IP telephone 5, with respect to each IP telephone 5. The route information generator 54 generates route information individually associating a plurality of network addresses individually corresponding to the plural addresses of the IP telephone 5 with the plural determined transfer destination routers.

The route information setter 55 sets the plural determined addresses in the IP telephone 5. For example, the IP telephone 5 may acquire a plurality of addresses from the route information setter 55 in accordance with a Dynamic Host Configuration Protocol (DHCP). In addition, the route information setter 55 sets the generated route information in the routing tables in the gateway router 7 and the router 7. For example, the route information setter 55 remotely logs in to the gateway router 7 and the router 7 through the maintenance network 9, and registers the generated route information in the routing tables.

In addition, the above-mentioned operations of the IP address determiner 50, the route calculator 53, and the route information generator 54 are performed by the processor 40 illustrated in FIG. 18. In accordance with an instruct of the processor 40, the network interface circuit 46 transmits the route information to the router 7 and transmits an IP address to the IP telephone 5, and hence, the above-mentioned operation due to the route information setter 55 is executed. The auxiliary storage device 41 and/or the memory 42 is used as the IP address storage unit 51 and the route information storage unit 52, and data stored in these is stored within the auxiliary storage device 41 and/or the memory 42.

### 3.3. Description of Operation of Network Management Device

FIG. 20 is the explanatory diagram of an example of generation processing for route information in the network control device 8. In an operation LA, with respect to each IP telephone 5, the IP address determiner 50 determines a plurality of addresses to be assigned to each IP telephone 5. In an operation LB, the processor 40 sets the value of an index variable i referring to each router to “1”. In an operation LC, the processor 40 sets the value of an index variable j referring to each IP telephone 5 to “1”.

In an operation LD, the route calculator 53 determines a plurality of routes leading from the i-th router 7 to the j-th IP telephone 5. In an operation LE, on the basis of the determined routes, the route information generator 54 selects a plurality of subsequent transfer destination routers used for transmitting a call packet from the i-th router 7 to the j-th IP telephone 5.

In an operation LF, the route calculator 53 generates route information associating the plural selected transfer destination routers with a plurality of network addresses individually corresponding to a plurality of addresses of the j-th IP telephone 5. In an operation LG, the route calculator 53 stores the generated route information in the route information storage unit 52. In an operation LH, the processor 40 increments the value of the variable j by “1”. When the value of the variable j is less than or equal to the number of IP telephones 5 (operation LI: Y), the processing returns to LD. When the value of the variable j is larger than the number of IP telephones 5 (operation LI: N), the processing proceeds to LJ.

In an operation LJ, the route information setter 55 sets the generated route information in the routing table of the i-th router 7. In an operation LK, the processor 40 increments the value of the variable i by “1”. When the value of the variable i is less than or equal to the number of routers 7 (operation LL: Y), the processing returns to LC. When the value of the variable i is larger than the number of routers 7 (operation LL: N), the processing is terminated.

In addition, while, in the present embodiment, the network control device 8 determines the address of the IP telephone 5, the network control device 8 may also acquire the address of the IP telephone 5 from a DHCP server, in another embodiment.

According to the present embodiment, since the setting processing for the address information of the IP telephone 5 and the route information of the gateway router 7 and the router 7 may be intensively performed by the network control device 8, the effort of the maintenance person of the communication system 1 may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device that performs communication through an IP network in accordance with a session control protocol, the communication device comprising:
a storage device configured to store plural addresses assigned to the communication device; a user interface device; and a controller, wherein the controller executes
processing that accepts an input of a user due to the user interface device, and
address switching processing that causes a transmission destination address, used by an opposite communication device to transmit data to the communication device, to be switched to another address included in the plural addresses in accordance with the session control protocol, in response to the input.

2. The communication device according to claim 1, wherein
the plural addresses are addresses where different routes are preliminarily assigned to route control devices in the IP network.

3. The communication device according to claim 2, wherein
the route control devices transfer packets in accordance with route information associating the plural addresses with different transfer destinations.

4. The communication device according to claim 1, wherein
the controller executes
processing that stores an address used at the end of a session, in the storage device, and
processing that designates the address used at the end of the session, as a transmission destination address in accordance with the session control protocol at the start of a session, the transmission destination address being used by the opposite communication device, which communicates with the communication device, to transmit data to the communication device.

5. The communication device according to claim 1, wherein
priority orders among the plural addresses are stored in the storage device, and
the controller executes processing that selects a transmission destination address caused to be used by the opposite communication device in the address switching processing, in accordance with the priority orders.

6. The communication device according to claim 1, wherein
priority orders among the plural addresses are stored in the storage device, and
the controller executes processing that designates an address whose priority order is the highest among the plural addresses, as a transmission destination address in accordance with the session control protocol at the start of a session, the transmission destination address being used by the opposite communication device, which communicates with the communication device, to transmit data to the communication device.

7. The communication device according to claim 6, wherein
the controller executes processing that selects a transmission destination address caused to be used by the opposite communication device in the address switching processing, in accordance with the priority orders.

8. A communication system comprising: an IP network; and a communication device configured to perform communication through the IP network in accordance with a session control protocol, wherein
in route control devices in the IP network, different routes are preliminarily set for plural addresses assigned to the communication device, and
the communication device includes a storage device configured to store the plural addresses, a user interface device, and a controller, wherein the controller executes
processing that accepts an input of a user due to the user interface device, and
address switching processing that causes a transmission destination address to be switched to another address included in the plural addresses in accordance with the session control protocol in response to the input, the transmission destination address being used by an opposite communication device, which communicates with the communication device, to transmit data to the communication device.

9. The communication system according to claim 8, further comprising:
a route setting device configured to set route information indicating a packet transfer destination, in the route control device, wherein
the route setting device includes a controller that executes
processing that determines, with respect to each of the communication devices, a plurality of packet transfer destinations used for transferring a packet to the communication device, with respect to each of the route control devices,
processing that generates route information associating the plural addresses included in each of the communication devices with the plural transfer destinations determined with respect to each of the communication devices, and
processing that sets the route information in the route control device.

10. The communication system according to claim 8, wherein
the controller executes
processing that stores an address used at the end of a session, in the storage device, and
processing that designates the address used at the end of the session, as a transmission destination address in accordance with the session control protocol at the start of a session, the transmission destination address being used by the opposite communication device, which communicates with the communication device, to transmit data to the communication device.

11. The communication system according to claim 8, wherein
priority orders among the plural addresses are stored in the storage device, and
the controller executes processing that selects a transmission destination address caused to be used by the opposite communication device in the address switching processing, in accordance with the priority orders.

12. The communication system according to claim 8, wherein
priority orders among the plural addresses are stored in the storage device, and
the controller executes processing that designates an address whose priority order is the highest among the plural addresses, as a transmission destination address in accordance with the session control protocol at the start of a session, the transmission destination address being used by the opposite communication device, which communicates with the communication device, to transmit data to the communication device.

13. The communication system according to claim 12, wherein
the controller executes processing that selects a transmission destination address caused to be used by the opposite communication device in the address switching processing, in accordance with the priority orders.

14. A session control method that controls a session due to a communication device performing communication through an IP network in accordance with a session control protocol, wherein
the communication device includes a storage device configured to store plural addresses assigned to the communication device, a user interface device, and a controller, wherein
the session control method causes the controller to execute
processing that accepts an input of a user due to the user interface device, and
address switching processing that causes a transmission destination address, used by an opposite communication device to transmit data to the communication device, to be switched to another address included in the plural addresses in accordance with the session control protocol, in response to the input.
